(19) United States
(12) Patent Application Publication
(10) Pub. No.: US 2019/0309806 A1
(43) Pub. Date: Oct. 10, 2019

(54) DRIVING FORCE DISTRIBUTION APPARATUS

(71) Applicant: JTEKT CORPORATION, Osaka-shi (JP)

(72) Inventors: Mikiharu Oyabu, Chiryu-shi (JP); Yoshinori Suzuki, Okazaki-shi (JP); Yuji Tsuzuki, Chiryu-shi (JP); Ryouichi Kubo, Kashihara-shi (JP); Naoki Ootawara, Kariya-shi (JP); Kazuteru Shinagawa, Kariya-shi (JP); Takahiro Kubo, Takahama-shi (JP); Yuji Niwa, Takahama-shi (JP)

(73) Assignee: JTEKT CORPORATION, Osaka-shi (JP)

(21) Appl. No.: 16/375,164

(22) Filed: Apr. 4, 2019

(30) Foreign Application Priority Data
Apr. 10, 2018 (JP) 2018-075507

(51) Int. Cl. F16D 48/02; B60K 17/35; B60K 23/08

(52) U.S. Cl. CPC F16D 25/14; B60K 2023/0858; B60K 23/0808; B60K 17/35

(57) ABSTRACT

A driving force distribution apparatus includes a hollow shaft configured to rotate together with a ring gear, a first output shaft having a shaft portion inserted through the hollow shaft, a second output shaft arranged coaxially with the first output shaft, and a driving force transmission mechanism configured such that a driving force transmitted to the hollow shaft is transmitted to the first and second output shafts. A case member has a lubricating oil introduction chamber into which lubricating oil stirred up by the ring gear is introduced. The lubricating oil is supplied from the lubricating oil introduction chamber to the driving force transmission mechanism via a space between the hollow shaft and the shaft portion of the first output shaft. The lubricating oil introduction chamber is formed between the hollow shaft and a bearing mechanism that supports one end of the first output shaft.

### INCORPORATION BY REFERENCE

The disclosure of Japanese Patent Application No. 2018-075507 filed on Apr. 10, 2018 including the specification, drawings and abstract, is incorporated herein by reference in its entirety.

### BACKGROUND OF THE INVENTION

### 1. Field of the Invention

The present invention relates to a driving force distribution apparatus configured to output a driving force input from a drive source while distributing the driving force to a pair of output shafts.

### 2. Description of the Related Art

Hitherto, a driving force distribution apparatus configured to output a driving force input from a drive source while distributing the driving force to a pair of output shafts is widely used as, for example, a differential apparatus configured to transmit the driving force to right and left wheels of a vehicle. As the differential apparatus, there is a differential apparatus capable of adjusting driving forces to be transmitted to each of the output shafts by multi-plate clutches to be pressed by hydraulic pressures (see, for example, Japanese Patent Application Publication No. 2011-149535 (JP 2011-149535 A)).

In the driving force distribution apparatus (rear differential gear) described in JP 2011-149535 A, a driven bevel gear that meshes with an input shaft is fixed to a hollow first sleeve, and a left output shaft is inserted through the first sleeve. An outer clutch portion is coupled to the first sleeve via a second sleeve and a drive plate. The outer clutch portion has right and left drum portions, and rotates together with the first sleeve. A right hydraulic clutch and a left hydraulic clutch are arranged between the right drum portion and a right output shaft and between the left drum portion and the left output shaft, respectively. Each of the right hydraulic clutch and the left hydraulic clutch is constituted by a plurality of frictional engagement members. The frictional engagement members are lubricated by lubricating oil that fills a housing.

A lubricating oil pump to be driven by the first sleeve is arranged in the housing. The lubricating oil discharged from the lubricating oil pump is introduced into an oil hole passing through the inner and outer peripheral surfaces of the first sleeve. The left output shaft has a hollow shape with a hollow portion inside. An oil hole is formed through the inner and outer peripheral surfaces of the left output shaft. The lubricating oil discharged from the lubricating oil pump is introduced into the oil hole of the left output shaft via the oil hole of the first sleeve. The lubricating oil introduced into the hollow portion of the left output shaft flows out from its right end to lubricate the frictional engagement members of the right hydraulic clutch and the left hydraulic clutch.

In the driving force distribution apparatus described in JP 2011-149535 A, the lubricating oil is introduced into the hollow portion of the left output shaft against a centrifugal force caused by rotation of the first sleeve and the left output shaft, owing to a discharge pressure of the lubricating oil pump. The number of components increases in such a lubricating oil pump, causing an increase in size and weight of the apparatus.

### SUMMARY OF THE INVENTION

It is one object of the present invention to provide a driving force distribution apparatus in which lubricating oil can be supplied, without a need for a lubricating oil pump, to a driving force transmission mechanism configured to transmit a driving force to a pair of output shafts.

A driving force distribution apparatus according to one aspect of the present invention includes:

a case member filled with lubricating oil;

a ring gear configured to rotate in the case member by receiving an input driving force;

a hollow shaft configured to rotate together with the ring gear;

a first output shaft having a shaft portion inserted through a hollow portion of the hollow shaft;

a second output shaft arranged so as to be coaxially rotatable relative to the first output shaft;

a driving force transmission mechanism configured such that the driving force transmitted to the hollow shaft is transmitted to the first output shaft and the second output shaft while a driving force transmission amount is variable; and

a plurality of bearings that support the hollow shaft, the first output shaft, and the second output shaft on the case member.

The case member has a lubricating oil introduction chamber into which the lubricating oil stirred up through rotation of the ring gear is introduced. The lubricating oil introduced into the lubricating oil introduction chamber is supplied to the driving force transmission mechanism via an oil path including a path between the hollow shaft and the shaft portion of the first output shaft. An end of the first output shaft that extends from the hollow shaft toward a side opposite to the driving force transmission mechanism is bearing-supported on the case member. The lubricating oil introduction chamber is formed between the bearing-supported end of the first output shaft and the hollow shaft.

According to the driving force distribution apparatus of the aspect described above, the lubricating oil can be supplied, without the need for the lubricating oil pump, to the driving force transmission mechanism configured to transmit the driving force to the pair of output shafts.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a structural diagram schematically illustrating an example of the structure of a four-wheel drive vehicle on which a driving force distribution apparatus according to an embodiment of the present invention is mounted;

FIG. 2 is a sectional view illustrating the driving force distribution apparatus in a horizontal cross section in a state in which the driving force distribution apparatus is mounted on the vehicle;

FIG. 3 is a sectional view illustrating the driving force distribution apparatus in a vertical cross section in the state in which the driving force distribution apparatus is mounted on the vehicle;

FIG. 4 is a sectional view illustrating a driving force transmission mechanism;

FIG. 5A is a sectional view of a hollow shaft and a first output shaft in a cross section including a line A-A in FIG. 4;

FIG. 5B is a sectional view of the hollow shaft, a clutch housing, and the first output shaft in a cross section including a line B-B in FIG. 4; and

FIG. 5C is a sectional view illustrating, together with the axial end face of a stopper ring, the cross section of the first output shaft in a cross section including a line C-C in FIG. 4.

### DETAILED DESCRIPTION OF EMBODIMENTS

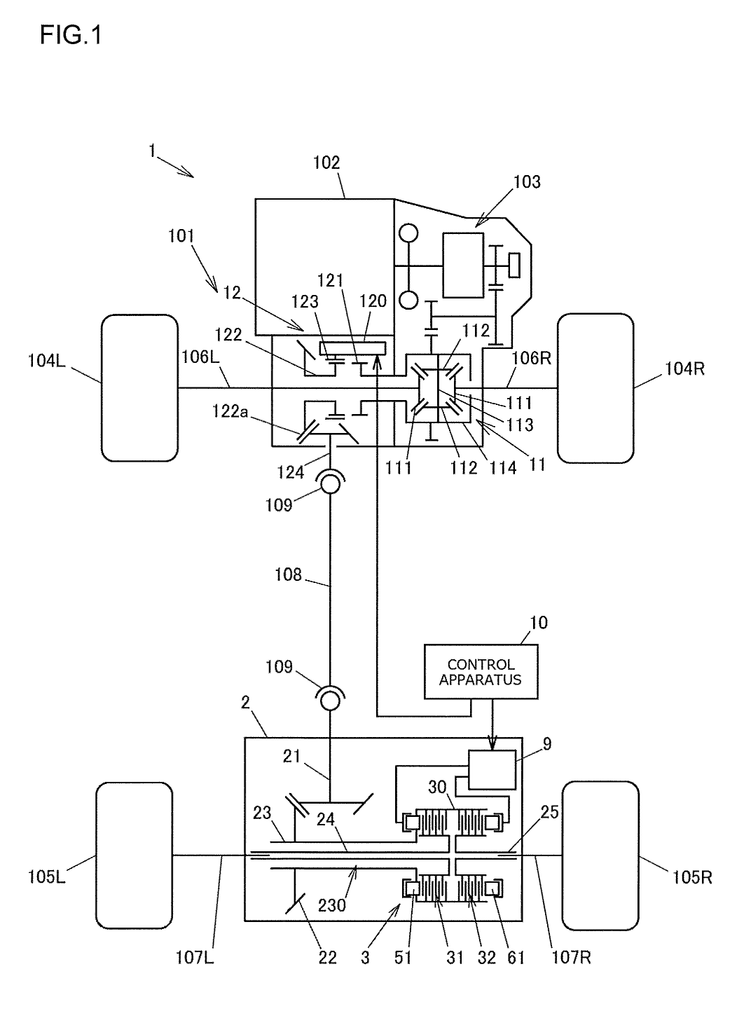

An embodiment of the present invention is described with reference to FIG. 1 to FIG. 5C.

FIG. 1 is a structural diagram schematically illustrating an example of the structure of a four-wheel drive vehicle on which a driving force distribution apparatus according to the embodiment of the present invention is mounted.

A four-wheel drive vehicle 1 includes an engine 102, a transmission 103, front wheels 104R and 104L, rear wheels 105R and 105L, a driving force transmission system 101, and a control apparatus 10. The engine 102 serves as a drive source configured to generate a driving force for traveling. The front wheels 104R and 104L serve as a pair of right and left main driving wheels. The rear wheels 105R and 105L serve as a pair of right and left auxiliary driving wheels. The driving force transmission system 101 is capable of transmitting the driving force of the engine 102 to the front wheels 104R and 104L and the rear wheels 105R and 105L.

The four-wheel drive vehicle 1 is switchable between a four-wheel drive mode and a two-wheel drive mode. In the four-wheel drive mode, the driving force of the engine 102 is transmitted to the front wheels 104R and 104L and the rear wheels 105R and 105L. In the two-wheel drive mode, the driving force of the engine 102 is transmitted only to the front wheels 104R and 104L. In this embodiment, the suffixes “R” and “L” of the reference symbols represent “right” and “left” of the vehicle, respectively.

The driving force transmission system 101 includes a front differential 11, a propeller shaft 108, a dog clutch 12, a driving force distribution apparatus 2, drive shafts 106R and 106L on the front wheel side, and drive shafts 107R and 107L on the rear wheel side. The propeller shaft 108 serves as a driving shaft configured to transmit the driving force of the engine 102 in a fore-and-aft direction of the vehicle. The dog clutch 12 connects or disconnects the driving force from the engine 102 side to the propeller shaft 108 side. The driving force distribution apparatus 2 distributes the driving force from the propeller shaft 108 toward the rear wheels 105R and 105L in an adjustable manner. The driving force of the engine 102 is constantly transmitted to the front wheels 104R and 104L via the drive shafts 106R and 106L on the front wheel side. The driving force of the engine 102 is transmitted to the rear wheels 105R and 105L in a disconnectable manner via the dog clutch 12, the propeller shaft 108, the driving force distribution apparatus 2, and the drive shafts 107R and 107L on the rear wheel side.

The control apparatus 10 controls the dog clutch 12 and the driving force distribution apparatus 2. In the four-wheel drive vehicle 1, under the control of the control apparatus 10, the driving force is transmitted to the rear wheels 105R and 105L via the dog clutch 12 and the driving force distribution apparatus 2 in the four-wheel drive mode, and the transmission of the driving force by the dog clutch 12 and the driving force distribution apparatus 2 is interrupted in the two-wheel drive mode. Thus, the propeller shaft 108 and the like stop their rotation in the two-wheel drive mode, whereby the fuel efficiency is improved.

The front differential 11 includes a pair of side gears 111, a pair of pinion gears 112, a pinion gear shaft 113, and a front differential case 114. The side gears 111 are coupled to the pair of drive shafts 106R and 106L on the front wheel side, respectively. The pinion gears 112 mesh with the side gears 111 with their gear axes set orthogonal to each other. The pinion gear shaft 113 supports the pinion gears 112. The front differential case 114 houses the side gears 111, the pinion gears 112, and the pinion gear shaft 113. The driving force of the engine 102 that is obtained through speed variation performed by the transmission 103 is transmitted to the front differential case 114.

The dog clutch 12 includes a first rotational member 121, a second rotational member 122, a sleeve 123, and an actuator 120. The first rotational member 121 rotates together with the front differential case 114. The second rotational member 122 is coaxially arranged side by side with the first rotational member 121. The sleeve 123 is capable of coupling the first rotational member 121 and the second rotational member 122 together so that the first rotational member 121 and the second rotational member 122 are not rotatable relative to each other. The actuator 120 is controlled by the control apparatus 10. The actuator 120 causes the sleeve 123 to move between a coupled position and a decoupled position. At the coupled position, the sleeve 123 meshes with the first rotational member 121 and the second rotational member 122. At the decoupled position, the sleeve 123 meshes with the second rotational member 122 alone. When the sleeve 123 is located at the coupled position, the first rotational member 121 and the second rotational member 122 are coupled together so as not to be rotatable relative to each other. When the sleeve 123 is located at the decoupled position, the first rotational member 121 and the second rotational member 122 are rotatable relative to each other.

The propeller shaft 108 receives the driving force of the engine 102 from the front differential case 114 via the dog clutch 12, and transmits the driving force toward the driving force distribution apparatus 2. A pair of universal joints 109 are attached to both ends of the propeller shaft 108. The universal joint 109 on the front side of the vehicle couples a pinion gear shaft 124 and the propeller shaft 108 together. The pinion gear shaft 124 meshes with a ring gear portion 122a provided on the second rotational member 122 of the dog clutch 12. The universal joint 109 on the rear side of the vehicle couples the propeller shaft 108 and a pinion gear shaft 21 of the driving force distribution apparatus 2 together.

The driving force distribution apparatus 2 includes the pinion gear shaft 21, a ring gear 22, a cylindrical hollow shaft 23, a first output shaft 24, a second output shaft 25, and a driving force transmission mechanism 3. The pinion gear shaft 21 serves as an input rotational member. The ring gear 22 meshes with the pinion gear shaft 21, and rotates by receiving the input driving force. The hollow shaft 23 rotates together with the ring gear 22. The first output shaft 24 is inserted through a hollow portion 230 of the hollow shaft 23. The second output shaft 25 is arranged so as to be coaxially rotatable relative to the first output shaft 24. The driving force transmission mechanism 3 is configured such that the driving force transmitted to the hollow shaft 23 is transmitted to the first and second output shafts 24 and 25 while a driving force transmission amount is variable. The drive shaft 107R is coupled to the second output shaft 25, and the drive shaft 107L is coupled to the first output shaft 24.

In the four-wheel drive mode, for example, the control apparatus 10 controls the driving force distribution apparatus 2 so that a greater driving force is transmitted to the rear wheels 105R and 105L as a differential rotation speed is higher or as the amount of a driver's depressing operation for an accelerator pedal is larger. The differential rotation speed is a difference between an average rotation speed of the front wheels 104R and 104L and an average rotation speed of the rear wheels 105R and 105L. At the time of making a turn, for example, the control apparatus 10 smooths the turn such that a driving force to be transmitted to a wheel on an outer side of turning out of the rear wheels 105R and 105L is set greater than a driving force to be transmitted to a wheel on an inner side of turning. Under an oversteering or understeering condition, the control apparatus 10 executes stability control for stabilizing the traveling condition by adjusting the driving forces to be transmitted to the rear wheels 105R and 105L.

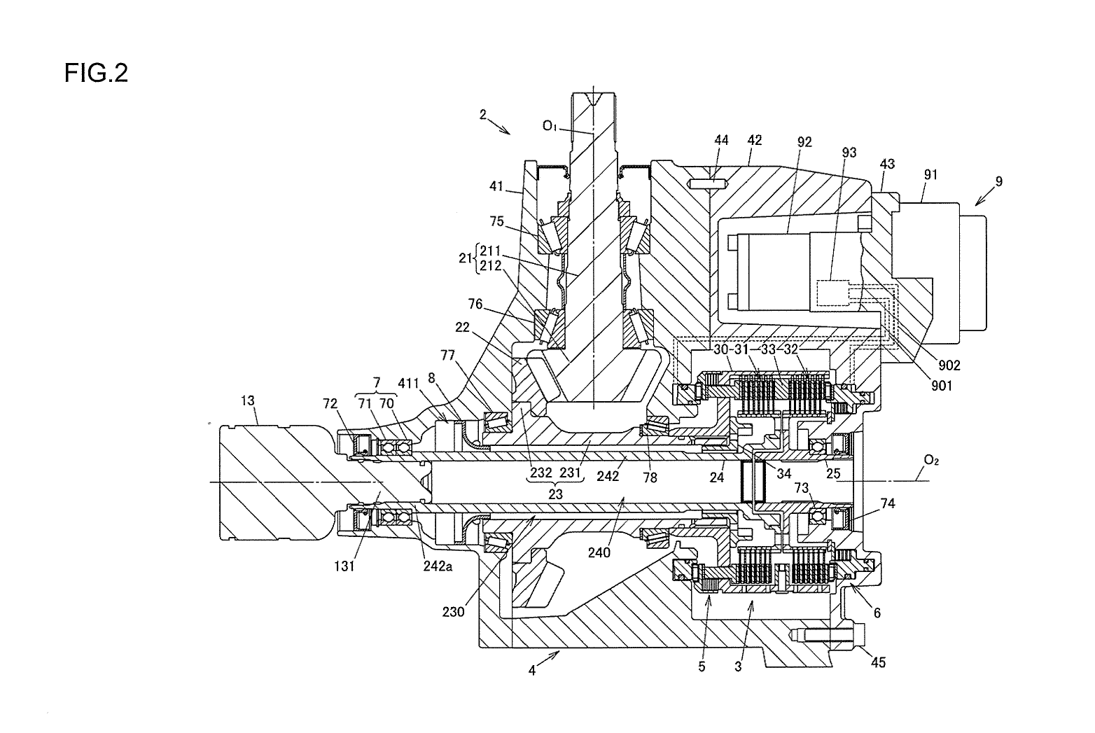

Next, the structure of the driving force distribution apparatus 2 is described in detail with reference to FIG. 2 to FIG. 5C.

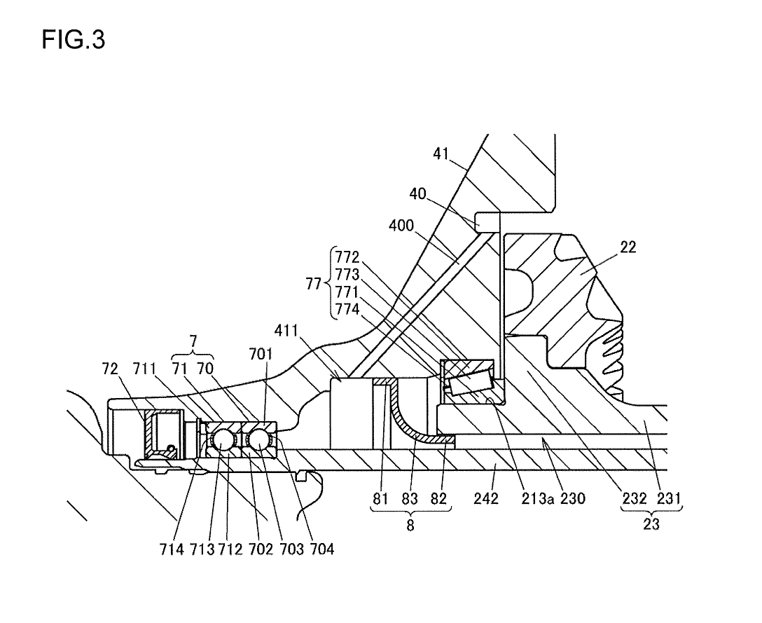

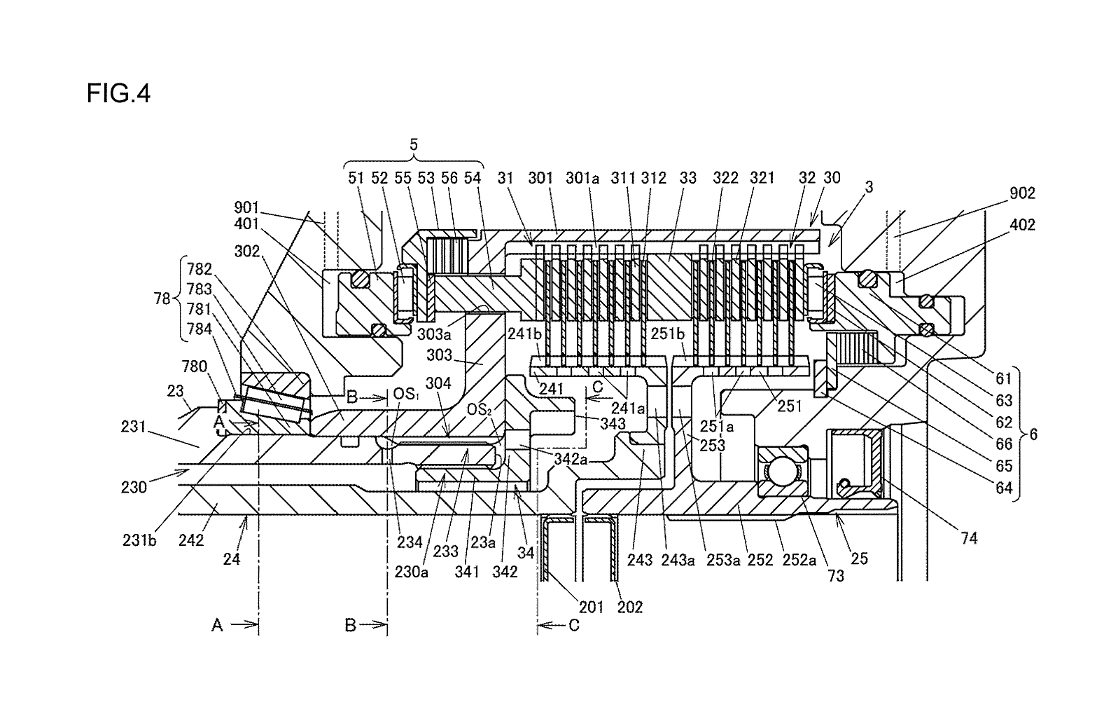

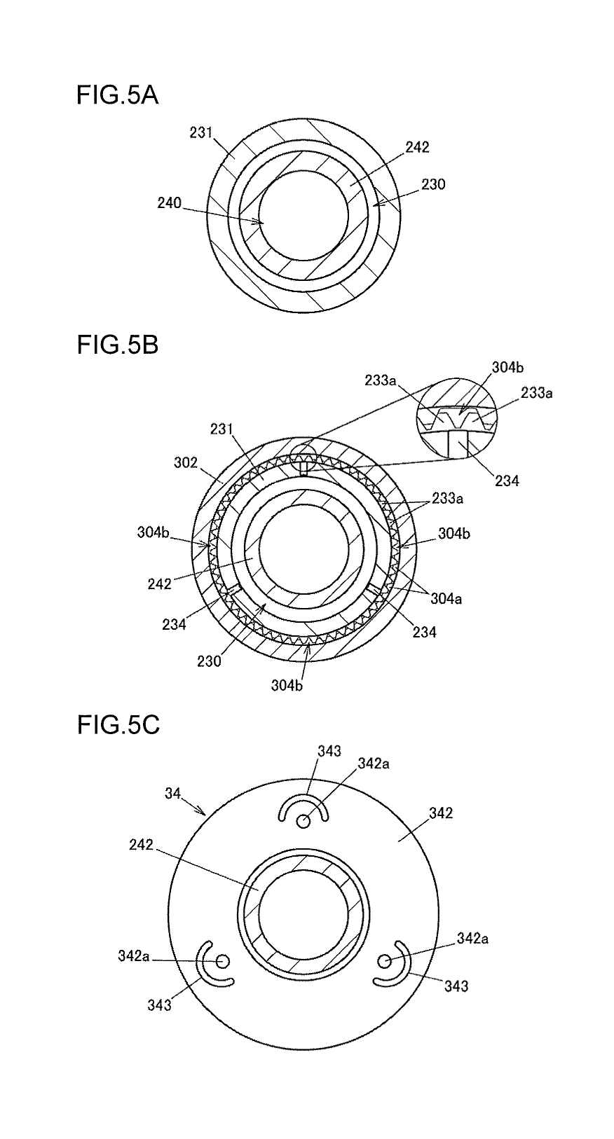

FIG. 2 is a sectional view illustrating the driving force distribution apparatus 2 in a horizontal cross section in a state in which the driving force distribution apparatus 2 is mounted on the vehicle. FIG. 3 is a sectional view illustrating a part of the driving force distribution apparatus 2 in a vertical cross section in the state in which the driving force distribution apparatus 2 is mounted on the vehicle. FIG. 4 is a sectional view illustrating the driving force transmission mechanism 3. FIG. 5A is a sectional view of the hollow shaft 23 and the first output shaft 24 in a cross section including a line A-A in FIG. 4. FIG. 5B is a sectional view of the hollow shaft 23, a clutch housing 30, and the first output shaft 24 in a cross section including a line B-B in FIG. 4. FIG. 5C is a sectional view illustrating, together with the axial end face of a stopper ring 34 described later, the cross section of the first output shaft 24 in a cross section including a line C-C in FIG. 4. An upper side in FIG. 3 corresponds to an upper side in a vertical direction in the state in which the driving force distribution apparatus 2 is mounted on the vehicle.

The driving force distribution apparatus 2 includes a case member 4 fixed to a vehicle body. The case member 4 houses the pinion gear shaft 21, the ring gear 22, the hollow shaft 23, the first and second output shafts 24 and 25, and the driving force transmission mechanism 3. The pinion gear shaft 21, the ring gear 22, the hollow shaft 23, and the first and second output shafts 24 and 25 are supported on the case member 4 by a plurality of bearings described later.

The case member 4 includes a case body 41, a case lid 42, and a support 43 that supports a hydraulic unit 9. The case body 41 and the case lid 42 are coupled together with a plurality of positioning pins 44 and a plurality of bolts 45. FIG. 2 illustrates one positioning pin 44 and one bolt 45. The case member 4 is filled with lubricating oil (not illustrated).

As illustrated in FIG. 4, the driving force transmission mechanism 3 includes the clutch housing 30, a first multi-plate clutch 31, a second multi-plate clutch 32, a partition wall 33, and the stopper ring 34. The clutch housing 30 has a large-diameter cylindrical portion 301 and a small-diameter cylindrical portion 302 having a diameter smaller than that of the large-diameter cylindrical portion 301. The first multi-plate clutch 31 is arranged between the large-diameter cylindrical portion 301 and the first output shaft 24. The second multi-plate clutch 32 is arranged between the large-diameter cylindrical portion 301 and the second output shaft 25. The partition wall 33 is interposed between the first multi-plate clutch 31 and the second multi-plate clutch 32. The stopper ring 34 serves as a retaining member configured to retain the clutch housing 30 on the hollow shaft 23.

The clutch housing 30 has a side wall portion 303 between the large-diameter cylindrical portion 301 and the small-diameter cylindrical portion 302. A plurality of insertion holes 303a are formed in the side wall portion 303. The first multi-plate clutch 31 is constituted by a plurality of first outer clutch plates 311 and a plurality of first inner clutch plates 312. The clutch plates 311 and 312 are arranged alternately. The second multi-plate clutch 32 is constituted by a plurality of second outer clutch plates 321 and a plurality of second inner clutch plates 322. The clutch plates 321 and 322 are arranged alternately. For example, the partition wall 33 is fixed to the inner surface of the large-diameter cylindrical portion 301 of the clutch housing 30 by welding, thereby restricting axial movement relative to the clutch housing 30.

The first output shaft 24 has a cylindrical clutch hub portion 241, a shaft portion 242, and an end wall portion 243. The clutch hub portion 241 faces the large-diameter cylindrical portion 301 of the clutch housing 30 in a radial direction. The shaft portion 242 has a spline fitting portion 242a to which one end of the drive shaft 107L is fitted so that the shaft portion 242 and the drive shaft 107L are not rotatable relative to each other. The end wall portion 243 is provided between the ends of the clutch hub portion 241 and the shaft portion 242. In this embodiment, the shaft portion 242 has a hollow cylindrical shape, and the spline fitting portion 242a is formed on the inner peripheral surface of a shaft hole 240 formed at the center of the shaft portion 242. FIG. 2 illustrates an outer race 13 of a constant velocity joint that is a part of the drive shaft 107L. A stem portion 131 of the outer race 13 is internally fitted to the spline fitting portion 242a.

The second output shaft 25 has a clutch hub portion 251, a hollow cylindrical shaft portion 252, and an end wall portion 253. The clutch hub portion 251 faces the large-diameter cylindrical portion 301 of the clutch housing 30 in the radial direction. A spline fitting portion 252a is formed on the inner peripheral surface of the shaft portion 252. One end of the drive shaft 107R is fitted to the spline fitting portion 252a so that the shaft portion 252 and the drive shaft 107R are not rotatable relative to each other. The end wall portion 253 is provided between the ends of the clutch hub portion 251 and the shaft portion 252.

A pair of end caps 201 and 202 for preventing leakage of the lubricating oil are attached to the shaft portion 242 of the first output shaft 24 and the shaft portion 252 of the second output shaft 25, respectively. In this embodiment, the first output shaft 24 is constituted by two members, and the two members are integrated by welding at the end wall portion 243. Alternatively, the entire first output shaft 24 may be formed integrally by using a single member. In this embodiment, the second output shaft 25 is formed integrally by using a single member. Alternatively, the second output shaft 25 may be constructed by coupling a plurality of members together by welding or the like.

One axial end of the first output shaft 24 that extends from the hollow portion 230 of the hollow shaft 23 toward a side opposite to the driving force transmission mechanism 3 is bearing-supported on the case member 4 by a bearing mechanism 7 having a plurality of rows of rolling elements 703 and 713. The first output shaft 24 is bearing-supported only by the bearing mechanism 7 in a cantilevered manner, and is not bearing-supported at a part closer to the driving force transmission mechanism 3 with respect to the hollow shaft 23 and in the hollow portion 230. A tilt of the first output shaft 24 with respect to the hollow shaft 23 is suppressed by the plurality of rows of rolling elements 703 and 713 of the bearing mechanism 7.

In this embodiment, the bearing mechanism 7 is constituted by a pair of ball bearings 70 and 71 arranged adjacent to each other in an axial direction between the outer peripheral surface of the shaft portion 242 of the first output shaft 24 and the inner surface of the case body 41. The ball bearings 70 and 71 include outer rings 701 and 711, inner rings 702 and 712, the plurality of rolling elements 703 and 713, and annular cages 704 and 714, respectively. The rolling elements 703 and 713 are retained by the cages 704 and 714, and are arranged along a circumferential direction in rows between the outer ring 701 and the inner ring 702 and between the outer ring 711 and the inner ring 712, respectively. The bearing mechanism 7 only needs to have a plurality of rows of rolling elements, and may be constituted by, for example, multi-row tapered roller bearings.

In this embodiment, the face of the outer ring 701 of one ball bearing 70 is in contact with the face of the outer ring 711 of the other ball bearing 71, and the face of the inner ring 702 of one ball bearing 70 is in contact with the face of the inner ring 712 of the other ball bearing 71. The present invention is not limited to this case. An intermediate member having a shape of a ring plate, such as a washer or a shim, may be arranged between the outer ring 701 of one ball bearing 70 and the outer ring 711 of the other ball bearing 71 or between the inner ring 702 of one ball bearing 70 and the inner ring 712 of the other ball bearing 71.

A seal member 72 for preventing leakage of the lubricating oil is arranged side by side with the ball bearings 70 and 71 between the outer peripheral surface of the shaft portion 242 of the first output shaft 24 and the open inner surface of the case body 41. The bearing mechanism 7 is lubricated by the lubricating oil in the case member 4.

A single ball bearing 73 and a seal member 74 are arranged between the outer peripheral surface of the shaft portion 252 of the second output shaft 25 and the open inner surface of the case lid 42. The second output shaft 25 is supported by the ball bearing 73 so as to be rotatable relative to the case member 4, and is coaxially rotatable relative to the first output shaft 24.

The clutch hub portion 241 of the first output shaft 24 has a plurality of oil holes 241a through which the lubricating oil flows. The clutch hub portion 251 of the second output shaft 25 has a plurality of oil holes 251a through which the lubricating oil flows. The end wall portion 243 of the first output shaft 24 and the end wall portion 253 of the second output shaft 25 have a plurality of oil holes 243a and 253a through which the lubricating oil flows, respectively.

A plurality of engagement protrusions 301a are formed on the inner peripheral surface of the large-diameter cylindrical portion 301 of the clutch housing 30. The first outer clutch plates 311 and the second outer clutch plates 321 engage with the engagement protrusions 301a. The engagement of the first outer clutch plates 311 and the second outer clutch plates 321 with the engagement protrusions 301a restricts rotation of the first outer clutch plates 311 and the second outer clutch plates 321 relative to the large-diameter cylindrical portion 301.

A plurality of engagement protrusions 241b are formed on the outer peripheral surface of the clutch hub portion 241 of the first output shaft 24. The first inner clutch plates 312 engage with the engagement protrusions 241b, thereby restricting rotation of the first inner clutch plates 312 relative to the first output shaft 24. A plurality of engagement protrusions 251b are formed on the outer peripheral surface of the clutch hub portion 251 of the second output shaft 25. The second inner clutch plates 322 engage with the engagement protrusions 251b, thereby restricting rotation of the second inner clutch plates 322 relative to the second output shaft 25.

The first multi-plate clutch 31 transmits the driving force between the clutch housing 30 and the first output shaft 24 by a friction force between the first outer clutch plates 311 and the first inner clutch plates 312. The second multi-plate clutch 32 transmits the driving force between the clutch housing 30 and the second output shaft 25 by a friction force between the second outer clutch plates 321 and the second inner clutch plates 322.

The driving force distribution apparatus 2 includes a first pressing mechanism 5 and a second pressing mechanism 6. The first pressing mechanism 5 presses the first multi-plate clutch 31 toward the partition wall 33 to bring the first outer clutch plates 311 and the first inner clutch plates 312 into frictional contact with each other. The second pressing mechanism 6 presses the second multi-plate clutch 32 toward the partition wall 33 to bring the second outer clutch plates 321 and the second inner clutch plates 322 into frictional contact with each other. As described above, the axial movement of the partition wall 33 relative to the clutch housing 30 is restricted. Therefore, the pressing force of the first pressing mechanism 5 is not applied to the second multi-plate clutch 32, and the pressing force of the second pressing mechanism 6 is not applied to the first multi-plate clutch 31.

The first pressing mechanism 5 includes a first piston 51, a thrust roller bearing 52, an annular pressure receiving member 53, a plurality of pressing members 54, a thrust washer 55, and a return spring 56. The first piston 51 receives a hydraulic pressure supplied from the hydraulic unit 9 to a first cylinder 401 via a first conduit 901. The thrust roller bearing 52 abuts against the first piston 51. The thrust roller bearing 52 is interposed between the first piston 51 and the pressure receiving member 53. The pressing members 54 are inserted through the insertion holes 303a of the side wall portion 303 of the clutch housing 30. The thrust washer 55 is inserted between the pressure receiving member 53 and the pressing members 54. The return spring 56 is arranged between the side wall portion 303 of the clutch housing 30 and the pressure receiving member 53 in a compressed state.

The second pressing mechanism 6 includes a second piston 61, a thrust washer 62, a thrust roller bearing 63, a snap ring 64, a washer 65, and a return spring 66. The second piston 61 receives a hydraulic pressure supplied from the hydraulic unit 9 to a second cylinder 402 via a second conduit 902. The thrust washer 62 and the thrust roller bearing 63 are arranged between the second piston 61 and the second multi-plate clutch 32. The snap ring 64 is fitted to the case lid 42. The washer 65 abuts against the snap ring 64. The return spring 66 is arranged between the washer 65 and the second piston 61 in a compressed state.

The pinion gear shaft 21 has a shaft portion 211 and a gear portion 212. The shaft portion 211 is supported on a pair of tapered roller bearings 75 and 76. The gear portion 212 is provided at one end of the shaft portion 211. The universal joint 109 on the rear side of the vehicle is coupled to the other end of the shaft portion 211. The pinion gear shaft 21 rotates about a rotation axis O₁ along the fore-and-aft direction of the vehicle. For example, the gear portion 212 of the pinion gear shaft 21 and the ring gear 22 that meshes with the gear portion 212 are hypoid gears. The driving force of the engine 102 is transmitted from the pinion gear shaft 21 to the ring gear 22. The ring gear 22 receives the driving force to rotate in the case member 4.

The hollow shaft 23 integrally has a hollow shaft portion 231 and a flange portion 232. The hollow portion 230 is formed at the center of the hollow shaft portion 231. The ring gear 22 is attached to the flange portion 232. The hollow shaft 23 rotates together with the ring gear 22 about a rotation axis O₂ along a vehicle width direction. The flange portion 232 is formed so as to protrude radially outward from the hollow shaft portion 231, and the ring gear 22 is fixed to the flange portion 232 by, for example, welding so as to rotate together with the flange portion 232. A direction parallel to the rotation axis O₂ is hereinafter referred to as an axial direction.

The shaft portion 242 of the first output shaft 24 is inserted through the hollow portion 230 of the hollow shaft portion 231 of the hollow shaft 23. A helical groove is formed on the inner peripheral surface of the hollow portion 230 at its one end. The part where the groove is formed is a threaded hole 230a. That is, in the hollow shaft 23, the hollow portion 230 including the threaded hole 230a is formed at the center of the hollow shaft portion 231, and passes through the hollow shaft portion 231 in the axial direction. The threaded hole 230a is formed so as to be open at one axial end face 23a of the hollow shaft 23.

In the case member 4, both ends of the hollow shaft 23 are bearing-supported by a pair of tapered roller bearings 77 and 78. The outer peripheral surface of the hollow shaft portion 231 of the hollow shaft 23 has bearing seating surfaces 231a and 231b to which inner rings 771 (see FIG. 3) and 781 of the tapered roller bearings 77 and 78 are fitted, respectively. The tapered roller bearings 77 and 78 include the inner rings 771 and 781, outer rings 772 and 782, a plurality of partially tapered rollers 773 and 783, and cages 774 and 784 that retain the rollers 773 and 783, respectively.

A funnel-shaped lubricating oil introduction member 8 is arranged on an outer peripheral side of the shaft portion 242 of the first output shaft 24. As illustrated in FIG. 3, the lubricating oil introduction member 8 integrally has a cylindrical fixing portion 81, a cylindrical tip portion 82, and a conical portion 83. The fixing portion 81 is fixed to the case body 41. The cylindrical tip portion 82 is inserted into the end of the hollow portion 230 of the hollow shaft 23. The bore diameter of the conical portion 83 gradually increases from the cylindrical tip portion 82 toward the fixing portion 81. The outer peripheral surface of the cylindrical tip portion 82 faces the inner peripheral surface of the hollow portion 230 via a small clearance. The inner peripheral surface of the cylindrical tip portion 82 faces the outer peripheral surface of the shaft portion 242 of the first output shaft 24 via a clearance larger than the clearance from the inner peripheral surface of the hollow portion 230.

An outer peripheral engagement portion 233 is provided on the outer peripheral surface of the hollow shaft portion 231 of the hollow shaft 23 at the end closer to the driving force transmission mechanism 3. The outer peripheral engagement portion 233 couples the clutch housing 30 to the hollow shaft 23 so that the clutch housing 30 and the hollow shaft 23 are not rotatable relative to each other. An inner peripheral engagement portion 304 is provided on the inner peripheral surface of the small-diameter cylindrical portion 302 of the clutch housing 30. The inner peripheral engagement portion 304 engages with the outer peripheral engagement portion 233 in the circumferential direction. As illustrated in FIG. 5B, the outer peripheral engagement portion 233 is formed of a plurality of spline protrusions 233a, and the inner peripheral engagement portion 304 is formed of a plurality of spline protrusions 304a. The spline protrusions 233a and 304a extend in parallel to each other along the axial direction. The engagement of the inner peripheral engagement portion 304 with the outer peripheral engagement portion 233 restricts rotation of the clutch housing 30 relative to the hollow shaft 23.

Axial movement of the clutch housing 30 relative to the hollow shaft 23 is not restricted by the engagement between the inner peripheral engagement portion 304 and the outer peripheral engagement portion 233, but the clutch housing 30 is retained on the hollow shaft 23 by the stopper ring 34. The axial position of the clutch housing 30 in the case member 4 is fixed by interposing the small-diameter cylindrical portion 302 between the inner ring 781 of the tapered roller bearing 78 and the stopper ring 34. The axial position of the inner ring 781 with respect to the hollow shaft 23 is adjusted by a shim 780. The inner ring 781 and the shim 780 may be arranged in reverse in the axial direction, and the end of the small-diameter cylindrical portion 302 may abut against the shim 780. A stepped portion having different diameters may be provided on the hollow shaft 23, and the end of the small-diameter cylindrical portion 302 may abut against the stepped portion.

The stopper ring 34 has an external thread portion 341, a facing wall portion 342, and a plurality of overhang portions 343. The external thread portion 341 serves as a fixing portion that is fixed to one end of the hollow shaft 23 by engaging with the threaded hole 230a of the hollow shaft 23. The facing wall portion 342 protrudes radially outward beyond the outer peripheral surface of the hollow shaft 23 to face the small-diameter cylindrical portion 302 and the side wall portion 303 of the clutch housing 30 in the axial direction. The tips of the overhang portions 343 are located on an inner side of the first multi-plate clutch 31. The external thread portion 341 of the stopper ring 34 is driven into the threaded hole 230a up to a position where the facing wall portion 342 pushes the small-diameter cylindrical portion 302 and the side wall portion 303 of the clutch housing 30 in the axial direction.

The hydraulic unit 9 includes an electric motor 91, a hydraulic pump 92, and a hydraulic circuit 93. The electric motor 91 generates a torque based on a motor current output from the control apparatus 10. The hydraulic pump 92 is actuated by the electric motor 91. The hydraulic circuit 93 supplies hydraulic oil discharged from the hydraulic pump 92 to the first and second conduits 901 and 902. The hydraulic circuit 93 includes control valves (not illustrated) configured to change their opening degrees based on a control current output from the control apparatus 10. The first and second conduits 901 and 902 are formed by holes provided in the case body 41, the case lid 42, and the support 43.

The control apparatus 10 outputs the motor current and the control current depending on the traveling conditions of the four-wheel drive vehicle 1 so that the hydraulic oil is supplied to the first and second conduits 901 and 902 at appropriate pressures. For example, at the time of making a turn to the right, the pressure of the hydraulic oil to be supplied to the first conduit 901 is increased to increase the driving force to be transmitted from the first multi-plate clutch 31 to the first output shaft 24. At the time of making a turn to the left, the pressure of the hydraulic oil to be supplied to the second conduit 902 is increased to increase the driving force to be transmitted from the second multi-plate clutch 32 to the second output shaft 25. For example, when the four-wheel drive mode is selected through a driver's selecting operation, both the pressures of the hydraulic oil to be supplied to the first and second conduits 901 and 902 are increased to switch the four-wheel drive vehicle 1 to the four-wheel drive mode.

Next, description is given of a lubrication structure for supplying the lubricating oil to the first and second multi-plate clutches 31 and 32. The lubricating oil stirred up through the rotation of the ring gear 22 is supplied to the first and second multi-plate clutches 31 and 32 via oil paths described later, thereby lubricating the frictional slide between the first outer clutch plates 311 and the first inner clutch plates 312 and the frictional slide between the second outer clutch plates 321 and the second inner clutch plates 322.

When the ring gear 22 rotates in the case member 4, the lubricating oil stored in the bottom of the case member 4 is stirred up, and a part of the stirred-up lubricating oil is introduced into a catch tank 40 illustrated in FIG. 3. The lubricating oil introduced into the catch tank 40 flows down a flow path 400 that communicates with the catch tank 40, and is introduced into a lubricating oil introduction chamber 411 formed on the outer peripheral side of the shaft portion 242 of the first output shaft 24 at a position closer to the drive shaft 107L (opposite to the ring gear 22) with respect to the lubricating oil introduction member 8. The lubricating oil introduction chamber 411 is formed into an annular shape in the case body 41 of the case member 4.

The lubricating oil introduction member 8 guides the lubricating oil introduced into the lubricating oil introduction chamber 411 to the hollow portion 230 of the hollow shaft 23, and suppresses leakage of the lubricating oil from the hollow portion 230. The lubricating oil introduction chamber 411 is formed between the part where the first output shaft 24 is bearing-supported by the bearing mechanism 7 and each of the hollow shaft 23 and the lubricating oil introduction member 8. A part of the lubricating oil introduced into the lubricating oil introduction chamber 411 is guided by the lubricating oil introduction member 8 to flow into the hollow portion 230 of the hollow shaft 23 through an inner side of the cylindrical tip portion 82, and is supplied to the driving force transmission mechanism 3 via an oil path including a path between the hollow shaft 23 and the shaft portion 242 of the first output shaft 24.

The hollow shaft 23 has a plurality of through holes 234 passing through the inner peripheral surface and the outer peripheral surface of the hollow shaft portion 231. In this embodiment, three through holes 234 are formed at equal intervals in the circumferential direction as illustrated in FIG. 5B. The through holes 234 are formed closer to the ring gear 22 with respect to the threaded hole 230a in the axial direction of the hollow shaft 23.

The members interposed between the hollow shaft 23 and the shaft portion 242 of the first output shaft 24 are not arranged in a region in the axial direction of the hollow shaft 23 between an inner peripheral opening of each through hole 234 and the lubricating oil introduction chamber 411. Therefore, the lubricating oil guided from the lubricating oil introduction chamber 411 to the path between the hollow shaft 23 and the shaft portion 242 of the first output shaft 24 flows in the axial direction without being blocked by the other members interposed between those two members. The lubricating oil introduced into the through hole 234 through the inner peripheral opening of the through hole 234 flows toward the outer peripheral surface of the hollow shaft portion 231 by a centrifugal force caused by the rotation of the hollow shaft 23. The through hole 234 is open at a part of the outer peripheral surface that is closer to the ring gear 22 with respect to the inner peripheral engagement portion 304 and the outer peripheral engagement portion 233.

In this embodiment, four splineless portions 304b (see FIG. 5B) each having no spline protrusion 304a are partially formed on the inner peripheral engagement portion 304 of the clutch housing 30. The lubricating oil flows through the splineless portions 304b. The splineless portions may be formed on the outer peripheral engagement portion 233 of the hollow shaft 23, or may be formed on both the inner peripheral engagement portion 304 and the outer peripheral engagement portion 233. That is, it is only necessary that the splineless portions be formed on at least one of the inner peripheral engagement portion 304 and the outer peripheral engagement portion 233.

An annular first oil reservoir OS₁ that communicates with the through holes 234 and the splineless portions 304b is formed between the hollow shaft portion 231 of the hollow shaft 23 and the small-diameter cylindrical portion 302 of the clutch housing 30. The lubricating oil flowing through the through holes 234 flows into the splineless portions 304b via the first oil reservoir OS₁. With the first oil reservoir OS₁, the lubricating oil flows smoothly even if the positions of the through holes 234 and the positions of the splineless portions 304b are misaligned in the circumferential direction.

The facing wall portion 342 of the stopper ring 34 has through holes 342a passing through the facing wall portion 342 in the axial direction. The lubricating oil flowing through a path between the small-diameter cylindrical portion 302 of the clutch housing 30 and the hollow shaft 23 flows through the through holes 342a. In an example illustrated in FIG. 5C, three through holes 342a are formed at equal intervals in the circumferential direction in the facing wall portion 342. An annular second oil reservoir OS₂ that communicates with the through holes 342a of the facing wall portion 342 of the stopper ring 34 and the splineless portions 304b is formed between the small-diameter cylindrical portion 302 of the clutch housing 30 and the facing wall portion 342. With the second oil reservoir OS₂, the lubricating oil flows smoothly even if the positions of the splineless portions 304b and the positions of the through holes 342a are misaligned in the circumferential direction.

The overhang portion 343 of the stopper ring 34 is provided on a radially outer side of an opening of the through hole 342a of the facing wall portion 342 that is opposite to the hollow shaft 23. In this embodiment, three overhang portions 343 corresponding to the three through holes 342a are formed so as to protrude in the axial direction from the facing wall portion 342 toward a space between the clutch hub portion 241 and the shaft portion 242 of the first output shaft 24. When the lubricating oil is scattered by the centrifugal force from the tips of the overhang portions 343 in their protruding direction, the lubricating oil adheres to the inner peripheral surface of the clutch hub portion 241, and is supplied to the first multi-plate clutch 31 through the oil holes 241a.

That is, the oil path from the lubricating oil introduction chamber 411 to the driving force transmission mechanism 3 includes the plurality of through holes 234 formed in the hollow shaft 23, the plurality of splineless portions 304b, and the plurality of through holes 342a formed in the facing wall portion 342 of the stopper ring 34. The lubricating oil flowing out of the through holes 342a of the facing wall portion 342 is guided into the first multi-plate clutch 31 by the overhang portions 343.

A part of the lubricating oil adhering to the inner peripheral surface of the clutch hub portion 241 is supplied to the second multi-plate clutch 32 via the oil holes 243a of the end wall portion 243 of the first output shaft 24 and the oil holes 253a of the end wall portion 253 of the second output shaft 25 or via a space between the end wall portions 243 and 253. The lubricating oil scattered from the overhang portions 343 of the stopper ring 34 may be supplied only to the first multi-plate clutch 31, and lubricating oil may be supplied to the second multi-plate clutch 32 with a different structure. That is, it is only necessary that the lubricating oil flowing through the path described above be supplied to at least the first multi-plate clutch 31.

According to the embodiment described above, the lubricating oil introduced into the lubricating oil introduction chamber 411 of the case member 4 is guided to the driving force transmission mechanism 3 by the centrifugal force caused by the rotation of the hollow shaft 23 and the like. Thus, the lubricating oil can be supplied to the driving force transmission mechanism 3 without the need for the lubricating oil pump unlike, for example, the related-art driving force distribution apparatus described above. Accordingly, an increase in the size and weight of the apparatus and an increase in costs can be suppressed.

The present invention may be modified as appropriate without departing from the spirit of the present invention. For example, the embodiment described above is directed to the case where the first and second multi-plate clutches 31 and 32 are pressed by the first and second pistons 51 and 52 that receive the hydraulic pressures, respectively. The present invention is not limited to this case. For example, each of the first and second multi-plate clutches 31 and 32 may be pressed by an axial cam thrust obtained by converting a rotational force of an electric motor by using a cam mechanism. Further, the structure of the four-wheel drive vehicle 1 is not limited to the structure exemplified in FIG. 1.

What is claimed is:

1. A driving force distribution apparatus, comprising:
a case member filled with lubricating oil;
a ring gear configured to rotate in the case member by receiving an input driving force;
a hollow shaft configured to rotate together with the ring gear;
a first output shaft having a shaft portion inserted through a hollow portion of the hollow shaft;
a second output shaft arranged so as to be coaxially rotatable relative to the first output shaft;
a driving force transmission mechanism configured such that the driving force transmitted to the hollow shaft is transmitted to the first output shaft and the second output shaft while a driving force transmission amount is variable; and
a plurality of bearings that support the hollow shaft, the first output shaft, and the second output shaft on the case member, wherein
the case member has a lubricating oil introduction chamber into which the lubricating oil stirred up through rotation of the ring gear is introduced,
the lubricating oil introduced into the lubricating oil introduction chamber is supplied to the driving force transmission mechanism via an oil path including a path between the hollow shaft and the shaft portion of the first output shaft,
an end of the first output shaft that extends from the hollow shaft toward a side opposite to the driving force transmission mechanism is bearing-supported on the case member, and
the lubricating oil introduction chamber is formed between the bearing-supported end of the first output shaft and the hollow shaft.

2. The driving force distribution apparatus according to claim 1, wherein the first output shaft is bearing-supported by a bearing mechanism having a plurality of rows of rolling elements.

3. The driving force distribution apparatus according to claim 1, wherein
the hollow shaft has a through hole passing through an inner peripheral surface and an outer peripheral surface of the hollow shaft, and
a member interposed between the hollow shaft and the first output shaft is not arranged in a region in an axial direction of the hollow shaft between an inner peripheral opening of the through hole and the lubricating oil introduction chamber.

4. The driving force distribution apparatus according to claim 1, wherein
the driving force transmission mechanism includes:
a clutch housing having a large-diameter cylindrical portion and a small-diameter cylindrical portion having a diameter smaller than a diameter of the large-diameter cylindrical portion;
a first multi-plate clutch arranged between the large-diameter cylindrical portion and the first output shaft and constituted by a plurality of clutch plates; and
a second multi-plate clutch arranged between the large-diameter cylindrical portion and the second output shaft and constituted by a plurality of clutch plates,
an inner peripheral engagement portion provided on an inner peripheral surface of the small-diameter cylindrical portion of the clutch housing engages with an outer peripheral engagement portion provided on the outer peripheral surface of the hollow shaft to restrict rotation of the clutch housing relative to the hollow shaft,
each of the inner peripheral engagement portion and the outer peripheral engagement portion is formed of a plurality of spline protrusions extending in parallel to each other along the axial direction, and
the oil path includes a splineless portion formed on at least one of the inner peripheral engagement portion and the outer peripheral engagement portion.

5. The driving force distribution apparatus according to claim 4, further comprising a retaining member configured to retain the clutch housing on the hollow shaft, wherein
the retaining member includes:
a fixing portion that is fixed to one end of the hollow shaft; and
a facing wall portion that protrudes radially outward beyond the outer peripheral surface of the hollow shaft to face the small-diameter cylindrical portion of the clutch housing in the axial direction, and
the oil path includes a through hole formed through the facing wall portion in the axial direction.

6. The driving force distribution apparatus according to claim 5, wherein an annular oil reservoir that communicates with the through hole of the facing wall portion of the retaining member is formed between the small-diameter cylindrical portion of the clutch housing and the facing wall portion.

7. The driving force distribution apparatus according to claim 5, wherein the retaining member includes an overhang portion provided on a radially outer side of an opening of the through hole of the facing wall portion that is opposite to the hollow shaft, and configured to guide the lubricating oil into the first multi-plate clutch.

8. The driving force distribution apparatus according to claim 1, further comprising a lubricating oil introduction member configured to guide the lubricating oil introduced into the lubricating oil introduction chamber to the hollow portion of the hollow shaft and to suppress leakage of the lubricating oil from the hollow portion, wherein
the lubricating oil introduction member includes:
a fixing portion that is fixed to the case member;
a cylindrical tip portion inserted into an end of the hollow portion; and
a conical portion whose bore diameter gradually increases from the cylindrical tip portion toward the fixing portion.
